(19) United States
(12) Patent Application Publication
(10) Pub. No.: US 2010/0189886 A1
(43) Pub. Date: Jul. 29, 2010

(54) Method For Making Data Storage Media

(75) Inventor: Yingguo Peng, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 12/360,191

(22) Filed: Jan. 27, 2009

(51) Int. Cl. G11B 5/82; B05D 5/00

(52) U.S. Cl. 427/130; 360/135; G9B/5.293

(57) ABSTRACT

A method for making a data storage media that includes providing a substrate, depositing on the substrate a first layer that includes a magnetic material and a non-magnetic material, heating the first layer, depositing on the first layer a second layer that includes the magnetic material and the non-magnetic material, and heating the second layer and the first layer. A data storage media constructed in accordance with the method of the invention is also provided.

### BACKGROUND

The invention relates to data storage media. The invention further relates to a method for making data storage media. In the field of data storage, areal density is an important factor driving future applications and recording systems. The areal density of current hard disc drive technology is fast approaching its theoretical limit for storage capabilities. Technologies such as, for example, perpendicular recording designs and heat (thermally) assisted magnetic recording (HAMR) designs have the potential to support much higher areal densities. Materials with increased magnetic anisotropies are desirable for various applications such as, for example, applications in the data storage industry where there is a continuous need to increase storage densities. Data storage media that can hold densities of 1 Tbit/in² or higher will require materials with magnetic anisotropies greater than conventional media materials. Heat treatments are typically used to control the phase formation and microstructure to optimize the materials properties. In order to incorporate these materials into a data storage media the correct crystalline phase must be obtained within a microstructure of fine, nanocrystalline, exchange decoupled or partially exchange decoupled grains. Thin film manufacturing techniques that can form nanocrystalline grains do not produce the correct phase on their own. For example, the FePt family is typically deposited as the face centered cubic (fcc) phase and subsequent annealing is needed to transform (i.e. chemically order) the material into the high anisotropy L1₀ phase.

There is identified a need for improved data storage media that overcomes limitations, disadvantages, and/or shortcomings of known data storage media.

### SUMMARY

An aspect of the present invention is to provide a method for making a data storage media that includes providing a substrate, depositing on the substrate a first layer that includes a magnetic material and a non-magnetic material, heating the first layer, depositing on the first layer a second layer that includes the magnetic material and the non-magnetic material, and heating the second layer and the first layer. In another aspect, the invention includes structuring the first layer and the second layer to form a magnetic recording layer. In another aspect, the invention further includes depositing on the first layer and the second layer an additional layer that includes the magnetic material and the non-magnetic material and then heating the additional layer and the second layer in the first layer. In another aspect, the invention includes structuring the first layer and the second layer and the additional layer to form a magnetic recording layer. In another aspect, the invention includes a data storage media constructed in accordance with the method of the invention described herein.

These and various other features and advantages will be apparent from a reading of the following detailed description.

### DRAWINGS

FIG. 1 is a pictorial representation of a system, in accordance with an aspect of the invention.

FIGS. 2a-2e schematically illustrate the method of making a data storage media, in accordance with an aspect of the invention.

FIG. 3 is a scanning electron microscope micrograph illustrating a plan view of an FePt—MgO film made in accordance with the method of invention, in accordance with an aspect of the invention.

### DETAILED DESCRIPTION

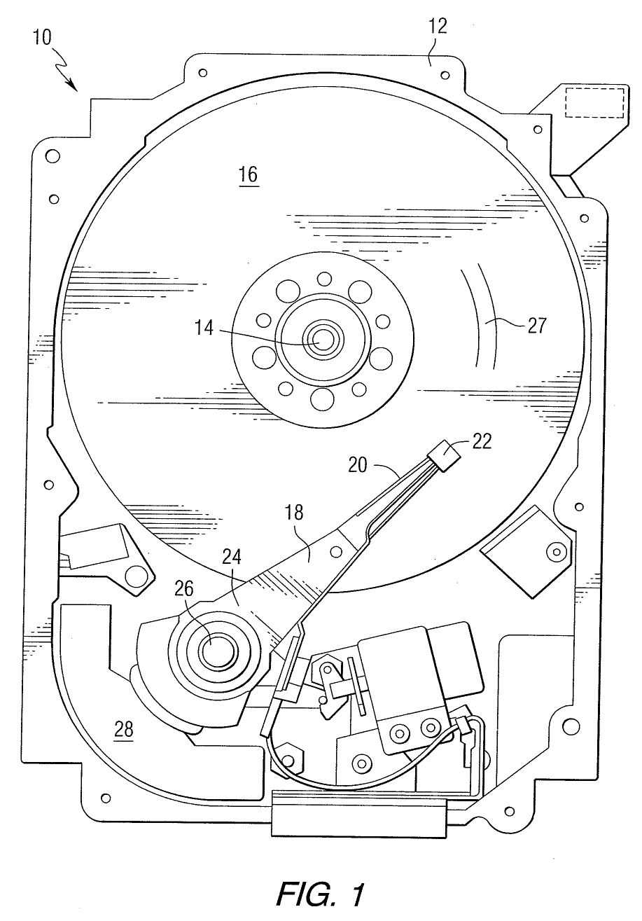

FIG. 1 is a pictorial representation of a system 10 that can include aspects of this invention. The system 10 includes a housing 12 (with the upper portion removed and the lower portion visible in this view) sized and configured to contain the various components of the system 10. The system 10 includes a spindle motor 14 for rotating at least one disc 16 within the housing 12. At least one actuator arm 18 is contained within the housing 12, with each arm 18 having a first end 20 with a slider 22, and a second end 24 pivotally mounted on a shaft by a bearing 26. An actuator motor 28 is located at the arm's second end 24 for pivoting the arm 18 to position the slider 22 over a desired sector 27 of the disc 16. The actuator motor 28 is regulated by a controller, which is not shown in this view and is well known in the art.

In one aspect, the invention relates to a data storage media. In another aspect, the invention relates to a method for making a data storage media. In another aspect, the data storage media may be structured and arranged for magnetic recording. In another aspect of the invention, the data storage media may be constructed and arranged for use in association with, for example, perpendicular magnetic recording or heat assisted magnetic recording (HAMR). However, it will be appreciated that aspects of the invention may be utilized for making other types of data storage media as well.

In fabricating a magnetic data storage media, elevated temperatures are necessary to fabricate materials into the high anisotropy L1₀ phase for magnetic recording media because the room temperature sputtering deposition product is magnetically soft A1 (fcc) phase. In production deposition tools, elevated temperatures may be obtained by applying heat at a separate process module other than that of sputtering deposition. Heating can be applied either prior to or post deposition process. In the case of preheating, the temperature drops significantly during the transport and film deposition, which poses a difficulty to achieve ordered L1₀ phase without overheating the substrates or deteriorating film microstructures. However, when applying post heating/annealing methods, the resulting microstructure of the L1₀ films are found to have grains too large to be used for high density recording.

In accordance with an aspect of the invention, the dilemma between obtaining ordered L1₀ phase and the microstructure suitable for high density recording can be solved by breaking the fabrication process into two or more alternating deposition-heating cycles. The number of cycles depend on the total film thickness desired and the cycle thickness can be optimized for desirable grain size. In one aspect, the method of the invention for each cycle includes sufficient heat applied to obtain the L1₀ phase, but the thickness of the single layer is optimized to achieve the desirable grain size. Further in accordance with the invention, to obtain granular microstructure the grain boundary additive material can be applied by a composite target (a sputtering target containing both magnetic and additive materials), by co-deposition with the magnetic material or by adding an additional layer of an appropriate amount of the additive material separately. The phase separation at elevated temperature drives the microstructure into granular type. In an aspect of the invention, various additives and heating powers can be applied at each cycle.

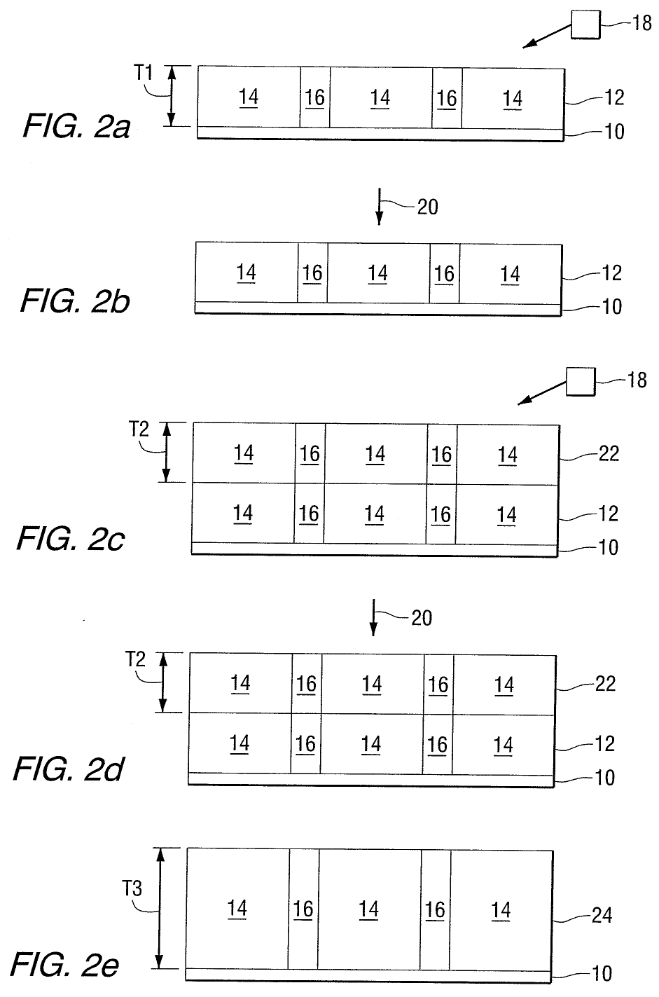

FIGS. 2a-2e schematically illustrate a method of the invention for making data storage media, in accordance with an aspect of the invention. It will be appreciated that FIGS. 2a-2e are merely provided for illustration purposes and that the method includes sputtering techniques and heating techniques that are generally known and, therefore, are not described in detail herein.

FIG. 2a illustrates providing a substrate 10 and depositing on the substrate a first layer 12 that includes a magnetic material 14 and a non-magnetic material 16, such as for example an oxide material. The magnetic material 14 and the non-magnteic material 16 may be sputter deposited from, for example, a composite target 18 that contains both the magnetic material and the non-magnetic material. In another aspect, the first layer 12 may be deposited by co-depositing from a first target containing the magnetic material and a second target containing the non-magnetic material. In another aspect, the first layer 12 may be deposited by depositing a magnetic layer from a first target containing the magnetic material and then depositing on the magnetic material a non-magnetic layer from a second target containing the non-magnetic material which will result then in the first layer 12 having magnetic regions containing the magnetic material 14 and non-magnetic boundary regions containing the non-magnetic material 16 that is interposed between the magnetic material. Accordingly, it will be appreciated that various steps of deposition may be utilized in accordance with the invention in order to obtain the first layer 12 that includes the magnetic material 14 and the non-magnetic material 16. It will be appreciated that additional underlayers and/or seedlayers (not shown) may be provided on the substrate as is generally known.

FIG. 2b illustrates heating of the first layer 12 (heating generally represented by arrow 20). The heating of the first layer 12 may be an in-situ heating process or an annealing process. Heating of the first layer 12 provides the temperature needed to transform the magnetic materal, e.g. FePt from fcc phase to L1₀ phase. Because the layer is relatively thin, the growth of the magnetic grains is controlled by the 3-D island mode and the grains are restricted to small sizes. On the other hand, due to different surface wetting conditions, the non-magnetic grain boundary material (usually oxide) forms a continuous matrix. As a result, a layer of granular L1₀ magnetic material, e.g. FePt is formed, although the thickness is usually smaller than what is needed to ultimately be a recording medium.

FIG. 2c illustrates depositing on the first layer 12 a second layer 22 that includes the magnetic material 14 and the non-magnetic material 16. The depositing of the second layer 22 may be performed in essentially the same manner as the depositing of the first layer 12. For the same reason of relatively thin thickness, the second layer 22 forms the same granular microstructure with small grain size and takes on the first layer 12 as a template. As a result, two deposited layers form one single layer (shown as two layers 12 and 22 in FIG. 2c for illustration purposes only) with granular microstructure and small grain size. By repeating the heat-deposition process, a desirable medium thickness can be reached with the microstructure suitable for recording media (as shown and will be explained in FIG. 2e).

FIG. 2d illustrates heating (generally represented by arrow 20) of the first layer 12 and the second layer 22. The heating of the first layer 12 and the second layer 22 may be performed in essentially the same manner as heating of the first layer 12, as described herein and illustrated in FIG. 2b.

FIG. 2e illustrates a magnetic recording layer such as, for example, a single magnetic recording layer 24 suitable for data storage, in accordance with the invention, following the deposition and heating of the first layer 12 and the second layer 22, as described herein. The magnetic recording layer 24 includes the magnetic material 14 with the non-magnetic material 16 interposed therebetween. It will be appreciated that the illustration of the magnetic material 14 and the non-magnetic material 16 in FIGS. 2a-2e are merely schematic illustrations

In one aspect, the magnetic material 14 includes at least one of FePt, CoPt, FePd, CoPd, NiPt, or AlMn. In another aspect, an additive used with the invention, such as, for example, the non-magnetic material 16 may include, for example, at least one of MgO, C, SiO₂, TiO₂, Ta₂O₅, Al₂O₃, BN, SiNₓ, B₄C or any suitable oxide material. In one aspect, the first layer 12 may be deposited to have a thickness T1 (see FIG. 2a), for example, in the range of about 0.2 nm to about 5.0 nm. In another aspect, the second layer 22 may have a thickness T2 (see FIG. 2c), for example, in the range of about 0.2 nm to about 5.0 nm. Accordingly, it will be appreciated that the thickness T1 of the first layer 12 and the thickness T2 of the second layer 22 may be selected as desired in order to obtain a magnetic recording layer 24 having an overall thickness T3 (see FIG. 2e) that is suitable for the desired density of data storage. It will be further appreciated that additional layers including the magnetic material and the non-magnetic material may be applied to the second layer 22 as desired and as will be explained herein.

In one aspect, the heating of the first layer 12 (as shown in FIG. 2b) may be done at a temperature in the range, for example, of about 350° C. to about 750° C.. In another aspect, the heating of the second layer 22 and the first layer 12 as illustrated in FIG. 2d may be done at a temperature in the range, for example, of about 350° C. to about 750° C.

In one aspect, the heating of the first layer 12 may be done for a period of time in the range, for example, of about 1.0 seconds to about 60.0 seconds. In another aspect, the heating of the second layer 22 and the first layer 12 may be done for a period of time in the range, for example, of about 1.0 seconds to about 60.0 seconds.

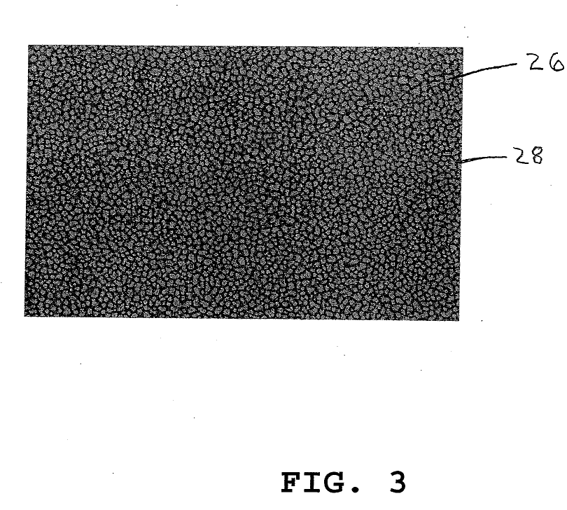

FIG. 3 illustrates a micrograph of a thin film formed in accordance with an aspect of the invention. Specifically, FIG. 3 illustrates a micrograph of FePt—MgO film structured as a magnetic recording layer such as, for example, magnetic recording layer 24 shown in FIG. 2e that is formed in accordance with the alternating deposition and heating method described in detail herein. The light colored grains 26 are the magnetic material, i.e., FePt and the gray boundaries 28 surrounding the FePt grains are the additive or non-magnetic material, i.e., MgO. In one aspect, the grains of the magnetic material, i.e., the FePt grains, have a size, for example, in the range of 2.0 nm to about 20.0 nm. In another aspect, the FePt—Mgo film, i.e., formed as a magnetic recording layer, has a magnetic anisotropy, for example, in the range of about 1×10⁷ erg/cc to about 10×10⁷ erg/cc. It will be appreciated that the film shown in FIG. 3 formed in accordance with the method of the present invention illustrates that the small grains with light contrast are the well ordered FePt grains and the gray boundaries are the non-magnetic material, for example MgO. This structure has the combination of small grain size, hard magnetic properties and granular microstructure which are necessary for high density magnetic recording media.

In one aspect of the invention, the method for forming a data storage media may include depositing on the first layer 10 and the second layer 12 an additional layer that includes the magnetic material 14 and the non-magnetic material 16. This is followed by then heating the additional layer and the second layer and the first layer. In an aspect of the invention, this depositing-heating cycle may be repeated as many times as desired in order to obtain the magnetic recording layer 24 having the desired overall thickness T3.

The implementation described above and other implementations are within the scope of the following claims.

What is claimed is:

1. A method for making a data storage media, comprising:
providing a substrate;
depositing on the substrate a first layer that includes a magnetic material and a non-magnetic material;
heating the first layer;
depositing on the first layer a second layer that includes the magnetic material and the non-magnetic material; and
heating the second layer and the first layer.

2. The method of claim 1, including the magnetic material comprising at least one of FePt, CoPt, FePd, CoPd, NiPt, or AlMn.

3. The method of claim 1, including the non-magnetic material comprising at least one of MgO, C, SiO₂, TiO₂, Ta₂O₅, Al₂O₃, BN, SiNₓ, B₄C.

4. The method of claim 1, including depositing the first layer to have a thickness in the range of about 0.2 nm to about 5.0 nm.

5. The method of claim 1, including depositing the second layer to have a thickness in the range of about 0.2 nm to about 5.0 nm.

6. The method of claim 1, including heating the first layer to a temperature in the range of about 350° C. to about 750° C..

7. The method of claim 1, including heating the first layer for a time in the range of about 1.0 seconds to about 60.0 seconds.

8. The method of claim 1, including heating the second layer and the first layer to a temperature in the range of about 350° C. to about 750° C..

9. The method of claim 1, including heating the second layer and the first layer for a time in the range of about 1.0 seconds to about 60.0 seconds.

10. The method of claim 1, including depositing the first layer and the second layer from a composite target containing the magnetic material and the non-magnetic material.

11. The method of claim 1, including depositing the first layer and the second layer by co-depositing from a first target containing the magnetic material and a second target containing the non-magnetic material.

12. The method of claim 1, including depositing the first layer and the second layer by depositing a magnetic layer from a first target containing the magnetic material and depositing on the magnetic layer a non-magnetic layer from a second target containing the non-magnetic material.

13. The method of claim 1, including structuring the first layer and the second layer to form a magnetic recording layer.

14. The method of claim 13, including grains of the magnetic material in the magnetic recording layer having a size in the range of about 2.0 nm to about 20.0 nm.

15. The method of claim 13, including the magnetic recording layer having a magnetic anisotropy in the range of about 1×10⁷ erg/cc to about 10×10⁷ erg/cc.

16. The method of claim 1, further including:
depositing on the first layer and the second layer an additional layer that includes the magnetic material and the non-magnetic material; and
heating the additional layer and the second layer and the first layer.

17. The method of claim 16, including structuring the first layer and the second layer and the additional layer to form a magnetic recording layer.

18. The method of claim 17, including grains of the magnetic material in the magnetic recording layer having a size in the range of about 2.0 nm to about 20.0 nm.

19. The method of claim 17, including the magnetic recording layer having a magnetic anisotropy in the range of about 1×10⁷ erg/cc to about 10×10⁷ erg/cc.

20. A data storage media constructed in accordance with the method of claim 1.
